(19) United States
(12) Patent Application Publication
(10) Pub. No.: US 2025/0018407 A1
(43) Pub. Date: Jan. 16, 2025

(54) SHOWER HEAD FOR A WATER FAUCET

(71) Applicant: Grohe AG, Hemer (DE)

(72) Inventor: Felix MUEHLING, Menden (DE)

(73) Assignee: Grohe AG, Hemer (DE)

(21) Appl. No.: 18/768,393

(22) Filed: Jul. 10, 2024

(30) Foreign Application Priority Data
Jul. 11, 2023 (DE) 10 2023 118 354.0

(51) Int. Cl. B05B 1/30; E03C 1/04

(52) U.S. Cl. CPC B05B 1/3026; E03C 1/0404

(57) ABSTRACT

A spray head (1) for a water faucet is (2) proposed that contains a line (3) for a liquid (4) having an inlet (5) and an outlet (6), a flow setting means (8) for setting a liquid flow rate through the line (3); an actuator (7) connected to the flow setting means (8); wherein the actuator (7) can be used to toggle the flow setting means (8) at least between a first position, in which the flow setting means (8) opens a first flow cross-section D1 (9) in the line (3), and a second position, in which the flow setting means (8) opens a second flow cross-section D2 (10) in the line (3), wherein a ratio V=D2/D1 is at least two.

This application claims priority to German Patent Application No. 10 2023 118 354.0, filed Jul. 11, 2023, which is incorporated by reference herein in its entirety.

This invention relates to a spray head for a water faucet.

A water faucet is a locally permanently installed device for dispensing water. In particular, the water faucet is connected to a water supply line, at least comprising a cold-water line, possibly additionally comprising a warm-water line. In particular, the water faucet comprises a thermostat (in a simplest design, a mixing device without its own temperature control), which can be used to mix warm water and cold water to form a tempered mixed water. The water is dispensed from the water faucet via an outlet.

The outlet can be formed, for instance, by a so-called spray head, which is connected to the faucet in a fixed or movable manner, possibly also via a flexibly deformable and possibly extendable hose.

The spray head or water faucet is particularly suitable for use in kitchens. Due to the growing need to conserve resources, it is desirable to reduce the consumption of water and energy (in particular, for instance, heated water) as much as possible. It is usually possible to set the flow rate of a water faucet using a matching (infinitely variable) setting device. To this end, a desired flow rate is set on demand. Frequently, a very high flow rate is selected, which is not required for most applications (washing hands, food or dishes).

The invention therefore addresses the problem of at least partially solving the issues described with reference to the prior art and, in particular, of providing a spray head for a water faucet, which simply and effectively reduces the consumption of water and energy.

These problems are solved by a spray head according to the features of the independent claim. Further advantageous embodiments of the invention are specified in the dependent claims. It will be appreciated that the features listed individually in the dependent claims may be combined in any technologically useful manner and define further embodiments of the invention. In addition, the features indicated in the claims are further specified and explained in the description, wherein further preferred embodiments of the invention are illustrated.

A spray head for a water faucet is proposed.

The spray head comprises at least:
a line for a liquid having an inlet and an outlet,
a flow setting means for setting a liquid flow rate through the line; and
an actuator connected to the flow setting means.

The actuator can be used to toggle the flow setting means at least between a first position, in which the flow setting means opens a (smallest) first flow cross-section D1 in the line, and a second position, in which the flow setting means opens a (smallest) second flow cross-section D2 in the line. A ratio V=D2/D1 is at least two.

In particular, the spray head can be connected to a water faucet in a fixed or movable manner, possibly also via a flexibly deformable and possibly extendable hose. In particular, the water faucet is connected to a water supply line, at least comprising a cold-water line, possibly additionally comprising a warm-water line. In particular, the water faucet comprises a thermostat (in a simplest design, a mixing device without its own temperature control), which can be used to mix warm water and cold water to form a tempered mixed water. The water is dispensed from the water faucet via an outlet. The outlet is formed in particular by the spray head, wherein the line of the spray head is fluidically connected to the cold-water and/or warm-water and/or mixed-water line of the water faucet.

It is in particular possible to set the flow rate at the water faucet using a matching (infinitely variable) setting device. To this end, a desired flow rate to the spray head is set as required. In particular, the flow setting means can then be used to further reduce this volumetric flow forwarded to the spray head if necessary.

Alternatively, the water faucet does not have a setting device for setting the flow rate, i.e., the flow rate can be set or changed solely by the spray head.

In particular, the flow cross-section generated by the flow setting means is the smallest individual flow cross-section in the line. The maximum possible flow rate flowing out of the line via the outlet of the line is therefore limited in particular only by the set flow cross-section.

In particular, a flow cross-section of the line is not completely closed by the flow setting means in any position. In particular, the flow setting means therefore cannot be used as a shut-off means, which could be used to reduce a volumetric flow through the line to zero.

In particular, the flow setting means is intended to limit the flow rate through the line in a first position to a maximum flow rate that is sufficient for most applications, whereas in the second position a significantly higher maximum flow rate desired for certain applications (e.g., for filling vessels) can be provided.

In particular, the ratio V=D2/D1 is greater than 2.5 or is at least three.

The spray head can be used to change the flow cross-section in the line, in particular incrementally. In particular, the flow cross-sections provided in the different positions differ significantly, such that if a sufficiently large volume flow is supplied to the line via the inlet, the actuator can be used to toggle between a small and a significantly larger volume flow.

In particular, the actuator can select only two positions. Alternatively, however, the actuator can also select several positions, wherein the ratio of the flow cross-sections is not increased, but only further subdivided, in particular in equal increments (i.e., the possible maximum volume flows per position then differ, for instance, by an equal amount of a volume flow, respectively).

In particular, the flow setting means is a throttle valve.

In particular, the throttle valve performs a rotary motion at least between the first position and the second position (possibly also between further positions). In particular, the throttle valve is pivoted in the line.

In particular, the actuator comprises a push mechanism and a transmission, wherein the transmission can convert a stroke motion of the push mechanism into a rotary motion for actuating the flow setting means.

Alternatively, the actuator can also perform a motion that corresponds to the motion of the flow setting means in the line. A transmission is then not required.

In particular, the push mechanism comprises a spring return device. The spring return device comprises at least one spring (compression spring, tension spring, disk spring, spiral spring, etc.).

Such push mechanisms are generally known from other applications. Every actuation can switch between the positions, wherein the push mechanism is returned to an initial position after every actuation. Alternatively, the push mechanism can remain in an initial position or in a depressed (intermediate) position after every actuation, wherein the spring return device can return the push mechanism to the initial position (or to the previous position) when the spring return device is actuated again.

In particular, the flow setting means can only be toggled between the first position and the second position.

In particular, continuous actuation of the actuator is required to maintain the second position. In particular, for instance, the push mechanism has to be kept pressed in order to maintain the second position.

Alternatively, once the actuator has been actuated, the selected position is maintained until the next actuation. In particular, for instance, the push mechanism does not have to be held down to maintain the second position, but a single actuation is sufficient to switch between the positions.

The spray head or the water faucet can of course also be used in other applications (outside a kitchen), e.g., in a sanitary facility, i.e., a facility for a person's personal hygiene. For this purpose, the sanitary device can, for instance, be designed in the manner of a shower or bathtub and/or be arranged in a sanitary room, such as a bathroom. Also, the sanitary device can be used for therapeutic applications. The sanitary device has at least one dispenser for a liquid. At least one of the dispensers then has the described spray head.

The water faucet or sanitary device also comprises, in particular, a thermostat (in a simplest design, a mixing device without its own temperature control), which can be used to mix warm water and cold water to form a tempered mixed water. The mixing thermostat can be used to mix the warm water and the cold water, which are each fresh water, to form water having a desired mixed-water temperature. A warm-water temperature of the warm water can in particular be a maximum of 90° C., preferably 25° C. (degrees Centigrade) to 90° C., particularly preferably 55° C. to 65° C., and/or a cold-water temperature of the cold water can in particular be a maximum of 25° C. (Centigrade), preferably 1° C. to 25° C., particularly preferably 5° C. to 20° C. The desired temperature of the liquid dispensed by the dispenser can be, for instance, 30° C. to 50° C., preferably 35° C. to 45° C., particularly preferably 35° C. to 40° C.

The warm water can be routed to the thermostat, for instance, from a warm-water source, such as a boiler, a (private and/or local) thermal solar system or a heat pump, via a warm-water line and/or the cold water from a cold-water source, such as a building-water connection, a public water-supply network or a (private/local) well, via a cold-water line. The warm-water line and/or the cold-water line may be at least partially in manner of a pipe. Further, the warm-water line and/or the cold-water line may extend at least partially through a building wall and/or floor. The thermostat may have a warm-water input for the warm water and/or a cold-water input for the cold water. The warm-water line may be connected to the warm water input and/or the cold-water line may be connected to the cold-water input. In addition, the thermostat may be at least partially located in a wall or floor of the building.

The mixed-water line can be at least partially designed in the form of a pipe and/or hose line and be fluidically connected to the line of the spray head.

A user of the water faucet or the sanitary device can set the desired temperature of the liquid dispensed via the spray head, for instance via an actuating element of the water faucet or the sanitary device and/or the thermostat.

The use of indefinite articles (“a”), in particular in the patent claims and the description repeating them, shall be understood as such and not as a numeral. Accordingly, terms or components introduced in that way shall be understood as being present at least once and, in particular, may also be present more than once.

As a precaution, it should be noted that the numeral words used here (“first”, “second”, . . . ) are primarily used to (only) distinguish between several similar objects, quantities or processes, i.e., in particular, they do not necessarily specify a dependency and/or sequence of these objects, quantities or processes with respect to each other. If a dependency and/or sequence is required, this is explicitly stated here or it is obvious to the person skilled in the art when studying the specific embodiment described. Insofar as a component may occur more than once (“at least one”), the description for one of these components can apply equally to all or a part of the majority of these components, but that is not mandatory.

The invention and the technical environment are explained in more detail below with reference to the figures attached. It should be noted that the invention is not intended to be restricted by the cited exemplary embodiments. In particular, it should be noted that the Figures and in particular the proportions shown are only schematic. In the figures,

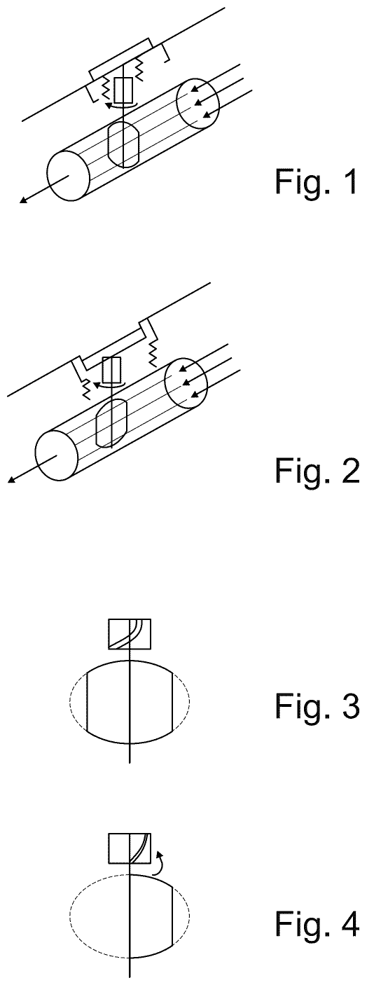

FIG. 1 shows a perspective view of a section of a spray head in a first state;

FIG. 2 shows a perspective view of a section of a spray head in a second state;

FIG. 3 shows a view along the line of a detail of the spray head of FIG. 1; and

FIG. 4 shows a view along the line of a detail of the spray head of FIG. 2.

FIG. 1 shows a perspective view of a section of a spray head 1 in a first state. FIG. 2 shows a perspective view of a section of a spray head 1 in a second state. FIG. 3 shows a view of a detail of the spray head 1 of FIG. 1 along the line 3. FIG. 4 shows a view of a detail of the spray head 1 of FIG. 2 along the line 3. FIGS. 1 and 4 are described jointly below.

A water faucet 2 is only indicated in FIG. 1. The spray head 1 forms the outlet 6 of the water faucet 2. The spray head 1 is also only shown as a section. However, the basic design of a spray head 1 is known, i.e., the spray head 1 is fixed or, as described, movably attached to a permanently installed water faucet 2. The spray head 1 has an outlet 6 from which the water (liquid 4) emerges and can then be used by a user (e.g., in a kitchen for washing or rinsing or filling).

The spray head 1 comprises a line 3 for a liquid 4 having an inlet 5 and an outlet 6, an actuator 7 for a flow setting means 8 for setting a liquid flow rate through the line 3, and the flow setting means 8 connected to the actuator 7.

The actuator 7 can toggle the flow setting means 8 between a first position, in which the flow setting means 8 opens a (smallest) first flow cross-section D1 9 (hatched area in FIG. 3) in the line 3, and a second position, in which the flow setting means 8 opens a (smallest) second flow cross-section D2 10 (hatched area in FIG. 4) in the line 3. A ratio V=D2/D1 is at least two.

the flow setting means 8 does not completely close the flow cross-section 9, 10 of the line 3 in any position. The flow setting means 8 therefore cannot be used as a shut-off means by which a volume flow through the line 3 could be reduced to zero.

The flow setting means 8 is intended to limit the flow rate through the line 3 in a first position to a maximum flow rate that is sufficient for most applications, whereas in the second position a significantly higher maximum flow rate desired for certain applications (e.g., for filling vessels) can be provided.

The spray head 1 can be used to incrementally change a flow cross-section 9, 10 in the line 3. The flow cross-sections 9, 10 provided in the different positions differ significantly, such that if a sufficiently large volume flow is supplied to the line 3 via the inlet 5, the actuator 7 can be used to toggle between a small and a significantly larger volume flow.

The actuator 7 can only be used to select two positions. The flow setting means 8 is a throttle valve. The throttle valve performs a rotary motion 11 between the first position and the second position. For this purpose, the throttle valve is pivoted in the line 3.

The actuator 7 comprises a push mechanism 12 and a transmission 13, wherein the transmission 13 can convert a stroke motion 14 of the push mechanism 12 into a rotary motion 11 for actuating the flow setting means 8.

The push mechanism 12 comprises a spring return device 15. The spring return device 15 comprises at least one spring 16.

Such push mechanisms 12 are generally known from other applications. Every actuation can toggle between the positions, wherein the push mechanism 12 is returned to an initial position (see FIG. 1) after every actuation. Alternatively, the push mechanism 12 can remain in an initial position (see FIG. 1) or in a depressed position (see FIG. 2) after every actuation, wherein the spring return device 15 can return the push mechanism 12 to the initial position when the spring return device is actuated again.

The flow setting means 8 can only be toggled between the first position (FIGS. 1 and 3) and the second position (FIGS. 2 and 4).

The spray head 1 can be used to reduce the consumption of water and energy simply and effectively, because an increased flow rate that is only required in certain applications has to be selected separately or specifically.

### LIST OF REFERENCE NUMERALS AND TERMS

1 spray head
2 water faucet
3 line
4 liquid
5 inlet
6 outlet
7 actuator
8 flow setting means
9 first flow cross-section D1
10 second flow cross-section D2
11 rotary motion
12 push mechanism
13 transmission
14 stroke motion
15 spring return device
16 spring

1. A spray head (1) for a water faucet (2) comprising
a line (3) for a liquid (4) having an inlet (5) and an outlet (6),
a flow setting means (8) for setting a liquid flow rate through the line (3), and
an actuator (7) connected to the flow setting means (8),
wherein the actuator (7) can be used to toggle the flow setting means (8) at least between a first position, in which the flow setting means (8) opens a first flow cross-section D1 (9) in the line (3), and a second position, in which the flow setting means (8) opens a second flow cross-section D2 (10) in the line (3), wherein a ratio V=D2/D1 is at least two.

2. The spray head (1) according to claim 1, wherein the ratio V=D2/D1 is greater than 2.5.

3. The spray head (1) according to claim 1, wherein the flow setting means (8) is a throttle valve.

4. The spray head (1) according to claim 3, wherein the throttle valve performs a rotary motion (11) between the first position and the second position.

5. The spray head (1) according to claim 1, wherein the actuator (7) comprises a push mechanism (12) and a transmission (13), wherein the transmission (13) can convert a stroke motion (14) of the push mechanism (12) into a rotary motion (11) for actuating the flow setting means (8).

6. The spray head (1) according to claim 5, wherein the push mechanism (12) comprises a spring return device (15).

7. The spray head (1) according to claim 1, wherein the flow setting means (8) can only be toggled between the first position and the second position.

8. The spray head (1) according to claim 1, wherein continuous actuation of the actuator (7) is required to maintain the second position.

9. The spray head (1) according to claim 1, wherein once the actuator (7) has been actuated, the selected position is maintained until the next actuation.
